(19) United States
(12) Patent Application Publication
(10) Pub. No.: US 2009/0002513 A1
(43) Pub. Date: Jan. 1, 2009

(54) IMAGING APPARATUS, IMAGING METHOD AND INTEGRATED CIRCUIT

(76) Inventors: Norikatsu YOSHIDA, Hyogo (JP); Shoji Nishikawa, Nara (JP); Tadami Mine, Osaka (JP); Hideyuki Furuya, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/131,705

(22) Filed: Jun. 2, 2008

(30) Foreign Application Priority Data
Jun. 1, 2007 (JP) 2007-147085

(51) Int. Cl. H04N 5/228

(52) U.S. Cl. 348/222.1; 348/E05.031

(57) ABSTRACT

An imaging apparatus requiring a large dynamic range captures an image including a moving image with an increased dynamic range without degrading resolution. In an imaging apparatus 100, an L/S separation unit 3 generates a long-signal and a short-signal based on a video signal output from an imaging unit 1, which includes an image sensor having a first group of pixels that accumulate charge for a first charge accumulation time and a second group of pixels that accumulate charge for a second charge accumulation time. A saturation detection unit 4 detects whether the long-signal is saturated. A saturated part of the long-signal is replaced with an interpolated long-signal, which is a signal having the same signal level as the long-signal obtained by interpolation using the short-signal. A selector unit 8 outputs the resulting long-signal as a corrected long signal. An L/S combining unit 9 sequentially switches the corrected long-signal and the corrected short-signal output from a multiplier to generate an output video signal. A drive unit 2 drives an imaging unit 1 in a manner that a center time of the first charge accumulation time and a center time of the second charge accumulation time coincide with each other.

### BACKGROUND OF THE INVENTION

1. Field of the Invention

The present invention relates to an imaging apparatus, an imaging method, and an integrated circuit for capturing an image including a moving image with an increased dynamic range without degrading resolution by combined use of an image sensor driving method and signal processing.

2. Description of the Related Art

Imaging apparatuses are widely used for various purposes in recent years. Depending on their purposes, the imaging apparatuses employ various methods proposed to, for example, improve the signal-to-noise (S/N) ratio of a captured image, enhance the resolution of a captured image, and increase the dynamic range of a captured image.

A conventional imaging apparatus with the dynamic range increasing function will now be described.

One example of the imaging apparatus that increases the dynamic range of a captured image is disclosed in Japanese Unexamined Patent Publication No. H9-116815. FIG. 5 shows the schematic structure of an image sensor unit 900 (formed by a charge-coupled device (CCD)) included in the conventional imaging apparatus. The image sensor unit 900 includes high-sensitivity pixels 19, which are arranged in the vertical direction, low-sensitivity pixels 20, which are arranged in the vertical direction, a vertical CCD 21, which transfers charge vertically, a horizontal CCD 22, which transfers charge horizontally, a limiter 23, which clips charge greater than or equal to a predetermined amount, and a charge detection unit 24 with a floating diffusion amplifier structure. In the image sensor unit 900, the high-sensitivity pixels 19 and the low-sensitivity pixels 20 are arranged alternately in the horizontal direction (horizontal direction in FIG. 5). More specifically, the high-sensitivity pixels 19 and the low-sensitivity pixels 20 are arranged alternately in a manner that vertical lines of the high-sensitivity pixels 19 and vertical lines of the low-sensitivity pixels 20 form stripes.

The operation of the conventional imaging apparatus including the image sensor unit 900 will now be described.

First, the charge generated through photoelectric conversion performed in the high-sensitivity pixels 19 and the charge generated through photoelectric conversion performed in the low-sensitivity pixels 20 are transferred all to the vertical CCD 21 in synchronization with a vertical sync signal. The charge transferred to the vertical CCD 21 is further transferred to the horizontal CCD 22 in synchronization with a horizontal sync signal. When the charge transferred to the horizontal CCD 22 is greater than or equal to a predetermined level, the charge is clipped by the limiter 23 before transferred to the charge detection unit 24. After clipped by the limiter 23, the charge transferred to the horizontal CCD 22 is transferred to the charge detection unit 24. A pulse applied to a reset gate RG is driven with a frequency that is half the frequency of a drive pulse of the horizontal CCD 22. As a result, the image sensor unit 900 outputs a signal generated by adding the charge obtained from adjacent high-sensitivity pixels and the charge obtained from low-sensitivity pixels.

As shown in FIG. 6, the amount of signal (amount of charge) obtained (output) from the high-sensitivity pixels 19 and the amount of signal (amount of charge) obtained (output) from the low-sensitivity pixels 20 increase proportionally as the amount of light increases. However, the amount of signal (amount of charge) output from the high-sensitivity pixels 19 becomes constant with a constant value D1 when the light amount exceeds a predetermined amount TH1, which is set by the limiter 23, and does not increase anymore. In contrast, the amount of signal (amount of charge) output from the low-sensitivity pixels 20 does not exceed the constant value D1 even after the light amount exceeds the predetermined amount TH1. The amount of signal (amount of charge) output from the low-sensitivity pixels 20 increases in proportion to the light amount even after the light amount increases to and above the predetermined amount TH1. The charge detection unit 24 combines the two pixel signals, that is, the signal formed by the charge obtained from the high-sensitivity pixels 19 and the signal formed by the charge obtained from the low-sensitivity pixels 20, by adding the two signals. The resulting signal (combined signal), which is obtained by the charge detection unit 24, has the characteristic indicated by L1 in FIG. 6. With the light amount—signal amount characteristic L1 in FIG. 5, the combined signal has a large dynamic range whose signal amount is not saturated even when the light amount is large.

FIG. 7 is a timing chart of various signals used in the image sensor unit 900.

Referring to FIG. 7, the timings of an output signal (which can form video (an image)) from the image sensor unit 900 (formed by a CCD), a read pulse signal, a charge accumulation time for high-sensitivity pixels and a charge accumulation time for low-sensitivity pixels, and a shutter pulse signal for low-sensitivity pixels will now be described.

As shown in FIG. 7(b), the image sensor unit 900 reads all pixel signals (electric signals generated through photoelectric conversion performed in pixels) using read pulse signals, each of which is output substantially simultaneously with a frame signal (electric signal whose cycle is equal to a period corresponding to one frame). Thus, pixels (high-sensitivity pixels) that accumulate charge for a long charge accumulation time (L [sec]) without using the electronic shutter function accumulate charge for the one-frame period as shown in FIG. 7(c). As shown in FIG. 7(d), when a shutter pulse signal, which enables the electronic shutter function, is output in the middle of each frame period, the low-sensitivity pixels start accumulating charge at the output timing of the shutter pulse signal. The charge accumulation time (S [sec]) for low-sensitivity pixels is a period from when the low-sensitivity pixels start accumulating charge to when a next read pulse signal is output. A period indicated using an arrow drawn with a thick line in FIG. 7(e) is the charge accumulation time for low-sensitivity pixels. In this case, the center time of the charge accumulation time for high-sensitivity pixels shown in FIG. 7(c) and the center time of the charge accumulation time for low-sensitivity pixels shown in FIG. 7(e) differ from each other by a time difference of L/2-S/2 [sec].

FIG. 8 is a timing chart describing the operation of an imaging apparatus disclosed in Unexamined Patent Publication No. H9-200621.

FIG. 8 shows the drive pulses of an image sensor (formed by a CCD) included in the imaging apparatus.

The image sensor of the imaging apparatus is driven with a read gate pulse VG, a vertical register transfer pulse VS, and a horizontal register transfer pulse VH, which have the speed double as the basis for a vertical sync pulse VD.

As shown in FIG. 8, the imaging apparatus divides one frame into a first-half frame period and a second-half frame period. In the first-half frame period, the imaging apparatus performs charge accumulation only for a period determined by a read gate pulse VG without inserting (outputting) a shutter pulse VP. As shown in FIG. 8(f), the imaging apparatus generates a signal with a long charge accumulation time indicated by an arrow 81 in the first-half frame period. In the second-half frame period, the imaging apparatus generates a signal with a short charge accumulation time indicated by an arrow 82 in FIG. 8(f) while inserting (outputting) a shutter pulse VP. The imaging apparatus then combines the two signals to generate a video signal. However, the signal generated with the long charge accumulation time 81 and the signal generated with the short charge accumulation time 82 have a large time lag as shown in FIG. 8(f). Thus, the imaging apparatus fails to generate a signal in an appropriate manner when a subject moves excessively within a one-frame period. When video (image) formed using the video signal generated by the imaging apparatus is displayed on a display device, the video (image) would be blurred on the display screen.

Patent Citation 1: Japanese Unexamined Patent Publication No. H9-116815

Patent Citation 2: Japanese Unexamined Patent Publication No. H9-200621

However, the imaging apparatus disclosed in Patent Citation 1 generates a signal corresponding to a single pixel by adding two pixels, and therefore degrades resolution.

The imaging apparatus disclosed in Patent Citation 2 generates two image signals (video signals) corresponding to one screen with two different charge accumulation times within a one-frame period and combines the two image signals, and therefore fails to shorten the processing time. More specifically, the imaging apparatus can generate only image signals corresponding to one screen within a one-frame period, and therefore fails to increase the processing speed to generate, for example, image signals corresponding to N screens (N is a natural number greater than 1) within a one-frame period. Also, when processing a moving image that contains movement within a one-frame period, the imaging apparatus would generate two image signals that have a time lag because the image sensor accumulates charge for two different charge accumulation times. When an image formed using an image signal that is obtained by combining the two image signals is displayed on a display device, the image (video) would be blurred on the display screen.

To solve the above problems, it is an object of the present invention to provide an imaging apparatus, an imaging method, and an integrated circuit for capturing an image with a large dynamic range, outputting a video signal that does not degrade resolution, and preventing video (image) including a moving image that contains excessive movement within a predetermined period (for example, a field period or a frame period) from blurring.

### SUMMARY OF THE INVENTION

A first aspect of the present invention provides an imaging apparatus including an imaging unit, a charge accumulation time setting unit, a drive unit, an L/S separation unit, a saturation detection unit, a correction value calculation unit, a multiplier unit, an interpolation unit, and an L/S combining unit. The imaging unit includes an image sensor and converts light from a subject to an electric signal to obtain a video signal. The image sensor has a plurality of pixels for each of which a charge accumulation time is set independently. The pixels are divided in a first group of pixels that accumulate charge for a first charge accumulation time and a second group of pixels that accumulate charge for a second charge accumulation time longer than the first charge accumulation time. The charge accumulation time setting unit sets the first charge accumulation time and the second charge accumulation time. The drive unit drives the imaging unit based on the first charge accumulation time and the second charge accumulation time. The L/S separation unit separates the video signal output from the imaging unit into a short-signal that is a video signal obtained with the first charge accumulation time and a long-signal that is a video signal obtained with the second charge accumulation time. The saturation detection unit detects a signal level of the long-signal. The correction value calculation unit calculates a correction value used to correct a signal level of the short-signal to the signal level of the long-signal based on the first charge accumulation time and the second charge accumulation time. The multiplier unit multiplies the short-signal by the correction value calculated by the correction value calculation unit to obtain a corrected short-signal. The interpolation unit performs interpolation using the corrected short-signal to generate an interpolated long-signal having a timing identical to a timing of the long-signal. The selector unit selects the long-signal when the saturation detection unit determines that the signal level of the long-signal is below or equal to a predetermined value, and selects the interpolated long-signal when the saturation detection unit determines that the signal level of the long-signal exceeds the predetermined value, and obtains the selected signal as a corrected long-signal. The L/S combining unit generates an output video signal by sequentially switching the corrected long signal output from the selector unit and the corrected short-signal output from the multiplier unit. The drive unit drives the imaging unit in a manner that a center time of the first charge accumulation time and a center time of the second charge accumulation time coincide with each other.

In this imaging apparatus, the L/S separation unit obtains a long-signal and a short-signal based on a video signal output from the imaging unit, which includes the image sensor having the first group of pixels that accumulate charge for the first charge accumulation time and the second group of pixels that accumulate charge for the second charge accumulation time. The saturation detection unit detects whether the long-signal is saturated, and replaces a saturated part of the long-signal with an interpolated long-signal, which is a signal having the same level as the long-signal obtained by interpolation using the short-signal. The selector unit outputs the resulting signal as a corrected long signal. The L/S combining unit sequentially switches the corrected long-signal and the corrected long-signal output from the multiplier unit to generate an output video signal. The drive unit drives the imaging unit in a manner that the center time of the first charge accumulation time and the center time of the second charge accumulation time coincide with each other.

More specifically, the imaging apparatus obtains a long-signal and a short-signal with the first and second charge accumulation times whose center times coincide with each other, and generates an output video signal by using an unsaturated part of the long-signal, which is a signal with a high S/N ratio obtained with the long charge accumulation time, and uses the short-signal obtained with the short charge accumulation time to replace a saturated part of the long-signal. Therefore, the imaging apparatus outputs the video signal without degrading resolution, and also effectively prevents video (image) including a moving image that contains excessive movement within a predetermined period (for example, a frame period or a field period) from blurring.

The “center time” herein refers to the intermediate time between the start and stop timings of charge accumulation defining the charge accumulation time. More specifically, the center time is written as (tt1+tt2)/2, where tt1 is the start timing of the charge accumulation and tt2 is the stop timing of the charge accumulation.

A second aspect of the present invention provides the imaging apparatus of the first aspect of the present invention in which the charge accumulation time setting unit sets an output timing of a second charge accumulation time start pulse signal used to determine the second charge accumulation time, an output timing of a first charge accumulation time start pulse signal used to determine the first charge accumulation time, and an output timing of a first charge accumulation time stop pulse signal. The drive unit drives the imaging unit in a manner that charge accumulation in the second group of pixels is started based on the second charge accumulation time start pulse signal and the charge accumulation in the second group of pixels is performed for the second charge accumulation time. The drive unit drives the imaging unit in a manner that charge accumulation in the first group of pixels is started based on the first charge accumulation time start pulse signal and the charge accumulation in the first group of pixels is stopped based on the first charge accumulation time stop pulse signal.

This imaging apparatus sets, for example, the cycle of the second charge accumulation time start pulse signal as a frame period, and starts the charge accumulation in the second group of pixels at the timing when the second charge accumulation time start pulse signal is output, and stops the charge accumulation in the second group of pixels at the timing when the next second charge accumulation time start pulse signal is output. Further, this imaging apparatus starts the charge accumulation in the first group of pixels based on the first charge accumulation time start pulse signal and stops the charge accumulation in the first group of pixels based on the first charge accumulation time stop pulse signal in a manner that the center times of the first charge accumulation time and the second charge accumulation time coincide with each other.

This structure easily enables the center times of the first charge accumulation time and the second charge accumulation time to coincide with each other.

A third aspect of the present invention provides the imaging apparatus of the first or second aspect of the present invention in which the image sensor includes the pixels arranged in a plurality of horizontal lines and a plurality of vertical lines, and the pixels included in the first group are arranged in odd vertical lines and the pixels included in the second group are arranged in even vertical lines.

This structure enables the video signal obtained by accumulating charge in the pixels arranged in the odd vertical lines to be obtained as the short-signal, and enables the video signal obtained by accumulating charge in the pixels arranged in the even vertical lines to be obtained as the long-signal.

A fourth aspect of the present invention provides the imaging apparatus in which the image sensor includes the pixels arranged in a plurality of horizontal lines and a plurality of vertical lines, and the pixels included in the first group are arranged in even vertical lines and the pixels included in the second group are arranged in odd vertical lines.

This structure enables the video signal obtained by accumulating charge in the pixels arranged in the even vertical lines to be obtained as the short-signal, and enables the video signal obtained by accumulating charge in the pixels arranged in the odd vertical lines to be obtained as the long-signal.

A fifth aspect of the present invention provides the imaging apparatus of the first or second aspect of the present invention, in which the image sensor includes the pixels arranged in a plurality of horizontal lines and a plurality of vertical lines, and the pixels included in the first group are arranged in odd horizontal lines and the pixels included in the second group are arranged in even horizontal lines.

This structure enables the video signal obtained by accumulating charge in the pixels arranged in the odd horizontal lines to be obtained as the short-signal, and enables the video signal obtained by accumulating charge in the pixels arranged in the even horizontal lines to be obtained as the long-signal.

A sixth aspect of the present invention provides the imaging apparatus of one of the first or second aspect of the present invention in which the image sensor includes the pixels arranged in a plurality of horizontal lines and a plurality of vertical lines, and the pixels included in the first group are arranged in even horizontal lines and the pixels included in the second group are arranged in odd horizontal lines.

This structure enables the video signal obtained by accumulating charge in the pixels arranged in the even horizontal lines to be obtained as the short-signal, and enables the video signal obtained by accumulating charge in the pixels arranged in the odd horizontal lines to be obtained as the long-signal.

A seventh aspect of the present invention provides the imaging apparatus of one of the first to sixth aspects of the present invention in which the image sensor is a complementary metal oxide semiconductor image sensor.

This structure enables the CMOS image sensor to be used as the image sensor of the imaging unit included in the imaging apparatus.

An eighth aspect of the present invention provides an imaging method used in an imaging apparatus including an imaging unit that includes an image sensor and converts light from a subject to an electric signal to obtain a video signal. The image sensor has a plurality of pixels for each of which a charge accumulation time is set independently. The pixels are divided in a first group of pixels that accumulate charge for a first charge accumulation time and a second group of pixels that accumulate charge for a second charge accumulation time longer than the first charge accumulation time. The method includes a charge accumulation time setting process, a drive process, an L/S separation process, a saturation detection process, a correction value calculation process, a multiplier process, an interpolation process, a selector process, and an L/S combining process. In the charge accumulation time setting process, the first charge accumulation time and the second charge accumulation time are set. In the drive process, the imaging unit is driven based on the first charge accumulation time and the second charge accumulation time. In the L/S separation process, the video signal output from the imaging unit is separated into a short-signal that is a video signal obtained with the first charge accumulation time and a long-signal that is a video signal obtained with the second charge accumulation time. In the saturation detection process, a signal level of the long-signal is detected. In the correction value calculation process, a correction value used to correct a signal level of the short-signal to the signal level of the long-signal is calculated based on the first charge accumulation time and the second charge accumulation time. In the multiplier process, the short-signal is multiplied by the correction value calculated in the correction value calculation process to obtain a corrected short-signal. In the interpolation process, the corrected short-signal is interpolated to generate an interpolated long-signal having a timing identical to a timing of the long-signal. In the selector process, the long-signal is selected when the signal level of the long-signal is determined to be below or equal to a predetermined value in the saturation detection process, and the interpolated long-signal is selected when the signal level of the long-signal is determined to exceed the predetermined value in the saturation detection process, and the selected signal is obtained as a corrected long-signal. In the L/S combining process, an output video signal is generated by sequentially switching the corrected long signal obtained in the selector process and the corrected short-signal obtained in the multiplier process. In the drive process, the imaging unit is driven in a manner that a center time of the first charge accumulation time and a center time of the second charge accumulation time coincide with each other.

The method has the same advantageous effects as the imaging apparatus of the first aspect of the present invention.

A ninth aspect of the present invention provides an integrated circuit that is used together with an imaging unit including an image sensor having a plurality of pixels for each of which a charge accumulation time is set independently. The pixels are divided in a first group of pixels that accumulate charge for a first charge accumulation time and a second group of pixels that accumulate charge for a second charge accumulation time longer than the first charge accumulation time. The integrated circuit includes a charge accumulation time setting unit, a drive unit, an L/S separation unit, a saturation detection unit, a correction value calculation unit, a multiplier unit, an interpolation unit, a selector unit, and an L/S combining unit. The charge accumulation time setting unit sets the first charge accumulation time and the second charge accumulation time. The drive unit drives the imaging unit based on the first charge accumulation time and the second charge accumulation time. The L/S separation unit separates the video signal output from the imaging unit into a short-signal that is a video signal obtained with the first charge accumulation time and a long-signal that is a video signal obtained with the second charge accumulation time. The saturation detection unit detects a signal level of the long-signal. The correction value calculation unit calculates a correction value used to correct a signal level of the short-signal to the signal level of the long-signal based on the first charge accumulation time and the second charge accumulation time. The multiplier unit multiplies the short-signal by the correction value calculated by the correction value calculation unit to obtain a corrected short-signal. The interpolation unit performs interpolation using the corrected short-signal to generate an interpolated long-signal having a timing identical to a timing of the long-signal. The selector unit selects the long-signal when the saturation detection unit determines that the signal level of the long-signal is below or equal to a predetermined value, and selects the interpolated long-signal when the saturation detection unit determines that the signal level of the long-signal exceeds the predetermined value, and obtains the selected signal as a corrected long-signal. The L/S combining unit generates an output video signal by sequentially switching the corrected long signal output from the selector unit and the corrected short-signal output from the multiplier unit. The drive unit drives the imaging unit in a manner that a center time of the first charge accumulation time and a center time of the second charge accumulation time coincide with each other.

When this integrated circuit is used together with the imaging unit, the integrated circuit has the same advantageous effects as the imaging apparatus of the first aspect of the present invention.

A tenth aspect of the present invention provides an integrated circuit including an imaging unit, a charge accumulation time setting unit, a drive unit, an L/S separation unit, a saturation detection unit, a correction value calculation unit, a multiplier unit, an interpolation unit, a selector unit, and an L/S combining unit. The imaging unit includes an image sensor and converts light from a subject to an electric signal to obtain a video signal. The image sensor has a plurality of pixels for each of which a charge accumulation time is set independently. The pixels are divided in a first group of pixels that accumulate charge for a first charge accumulation time and a second group of pixels that accumulate charge for a second charge accumulation time longer than the first charge accumulation time. The charge accumulation time setting unit sets the first charge accumulation time and the second charge accumulation time. The drive unit drives the imaging unit based on the first charge accumulation time and the second charge accumulation time. The L/S separation unit separates the video signal output from the imaging unit into a short-signal that is a video signal obtained with the first charge accumulation time and a long-signal that is a video signal obtained with the second charge accumulation time. The saturation detection unit detects a signal level of the long-signal. The correction value calculation unit calculates a correction value used to correct a signal level of the short-signal to the signal level of the long-signal based on the first charge accumulation time and the second charge accumulation time. The multiplier unit multiplies the short-signal by the correction value calculated by the correction value calculation unit to obtain a corrected short-signal. The interpolation unit performs interpolation using the corrected short-signal to generate an interpolated long-signal having a timing identical to a timing of the long-signal. The selector unit selects the long-signal when the saturation detection unit determines that the signal level of the long-signal is below or equal to a predetermined value, and selects the interpolated long-signal when the saturation detection unit determines that the signal level of the long-signal exceeds the predetermined value, and obtains the selected signal as a corrected long-signal. The L/S combining unit generates an output video signal by sequentially switching the corrected long signal output from the selector unit and the corrected short-signal output from the multiplier unit. The drive unit drives the imaging unit in a manner that a center time of the first charge accumulation time and a center time of the second charge accumulation time coincide with each other.

This integrated circuit has the same advantageous effects as the imaging apparatus of the first aspect of the present invention.

The present invention provides an imaging apparatus, an imaging method, and an integrated circuit for capturing an image with a large dynamic range, outputting a video signal that does not degrade resolution and preventing video (image) including a moving image that contains excessive movement within a predetermined period (for example, a field period or a frame period) from blurring.

### BRIEF DESCRIPTION OF THE DRAWINGS

FIG. 1 shows the structure of an imaging apparatus 100 according to a first embodiment of the present invention.

FIG. 2 shows the structure of an imaging unit 1 and a drive unit 2 according to the first embodiment.

FIG. 3 is a timing chart showing the drive timings of the imaging apparatus according to the first embodiment.

FIG. 4 is a waveform diagram describing the operation of the imaging apparatus according to the first embodiment.

FIG. 5 shows the structure of a conventional imaging apparatus.

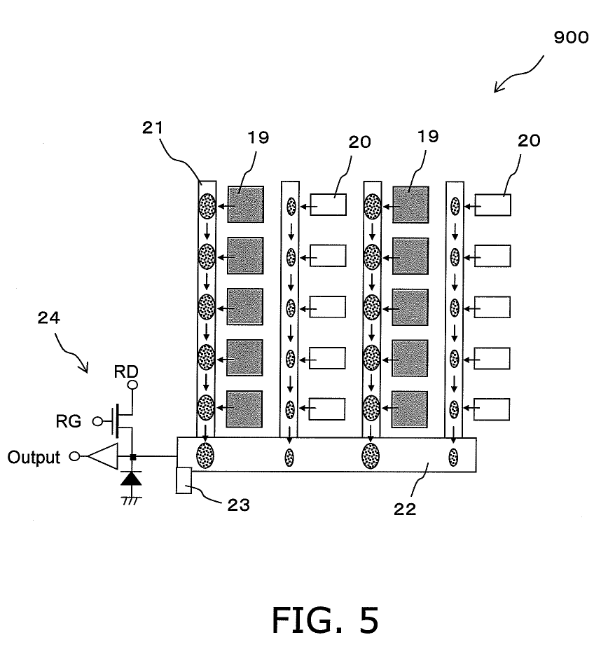

FIG. 6 is a diagram describing dynamic range increase performed in the imaging apparatus.

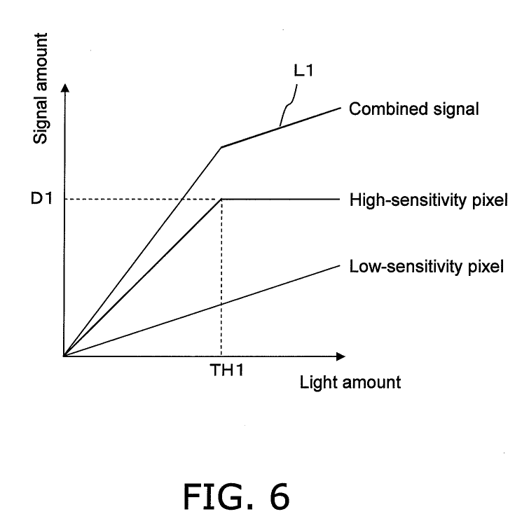

FIG. 7 is a timing chart showing the drive timings of the conventional imaging apparatus.

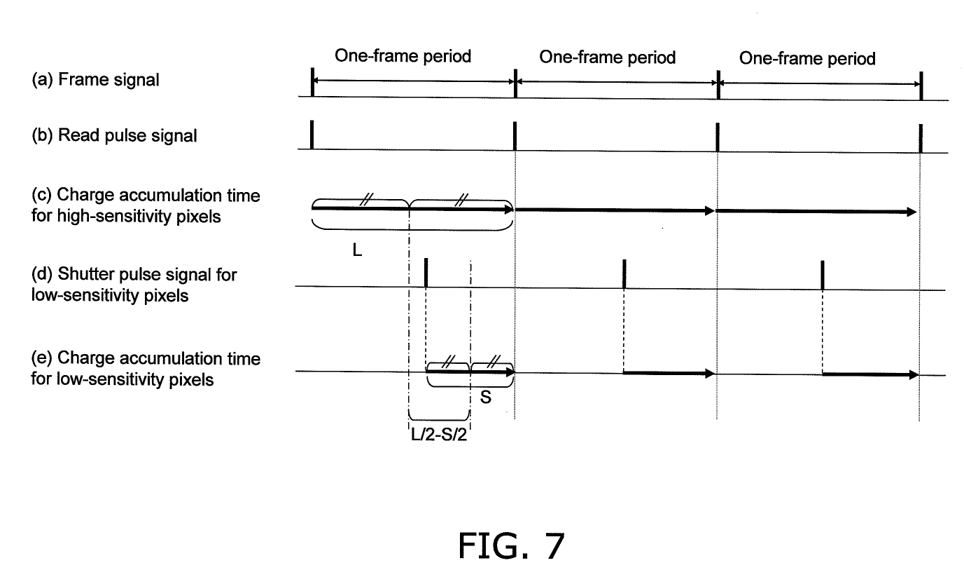

FIG. 8 is a timing chart showing the drive timings of the conventional imaging apparatus.

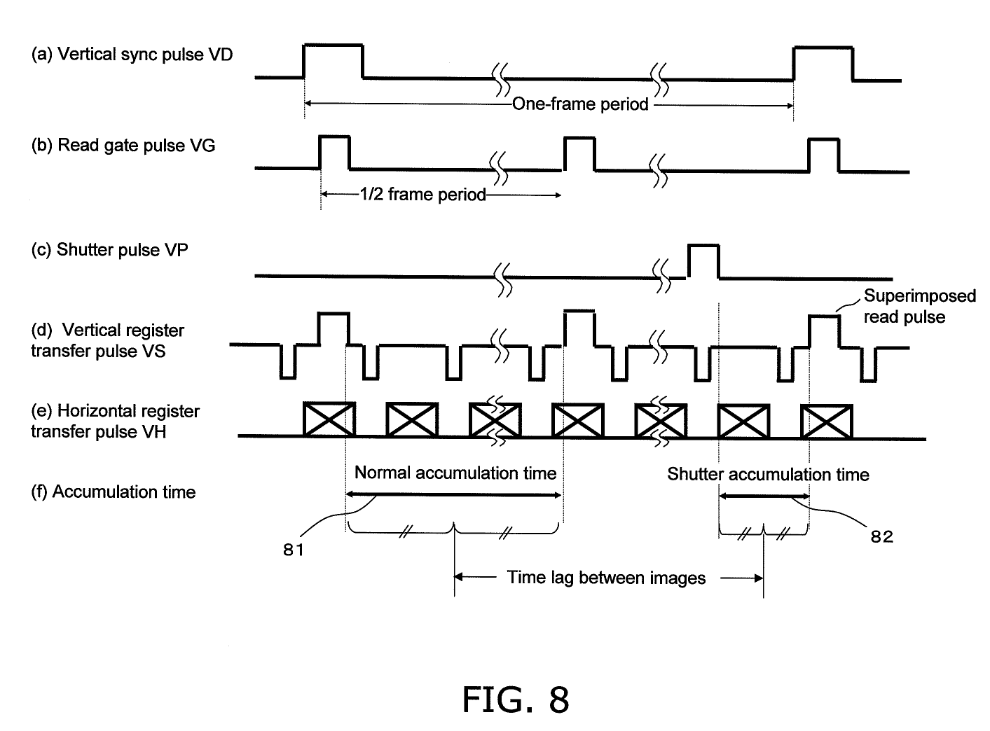

### DETAILED DESCRIPTION OF THE PREFERRED EMBODIMENTS

Embodiments of the present invention will now be described with reference to the drawings.

### First Embodiment

### Structure of the Imaging Apparatus

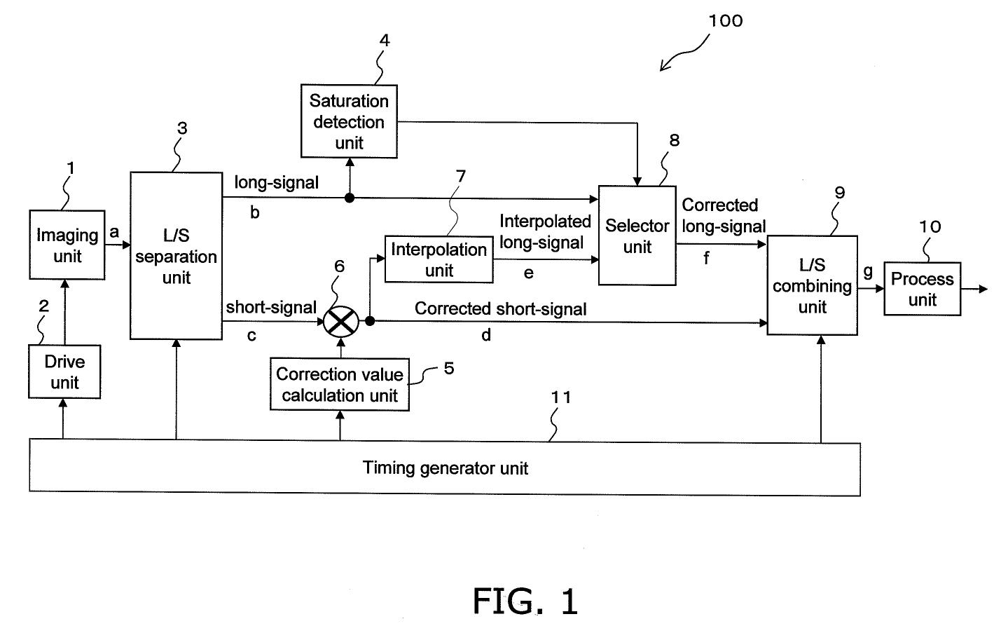

FIG. 1 shows the structure of an imaging apparatus 100 according to a first embodiment of the present invention.

The imaging apparatus 100 includes an imaging unit 1, a drive unit 2, an L/S separation unit 3, a saturation detection unit 4, a correction value calculation unit 5, a multiplier unit 6, and an interpolation unit 7. The drive unit 2 drives the imaging unit 1. The L/S separation unit 3 separates a video signal, which is obtained by the imaging unit 1, depending on whether the charge accumulation time for each pixel is long or short. The saturation detection unit 4 detects whether the level of a signal obtained from pixels with a long charge accumulation time (hereafter referred to as a “long-signal”) exceeds a predetermined level. The correction value calculation unit 5 corrects a pixel output level, which changes depending on the charge accumulation time. The multiplier unit 6 corrects a “short-signal” to correct the level of a signal lowered due to the charge accumulation time and obtains a corrected short-signal. Based on the corrected short-signal, the interpolation unit 7 generates an interpolated long-signal, which has the same timing as the timing corresponding to the center point of the corrected short-signal, or in other words the same timing as the timing of the long-signal. The imaging apparatus 100 further includes a selector unit 8, an L/S combining unit 9, a process unit 10, and a timing generator unit 11. The selector unit 8 selects one of the long-signal and the interpolated long-signal based on a detection result in the saturation detection unit 4. The L/S combining unit 9 sequentially switches the corrected long-signal and the corrected short-signal when generating a video signal. The process unit 10 subjects the video signal to signal processing for cameras, such as gamma correction and detail enhancement. The timing generator unit 11 generates signals including a sync signal for cameras and a drive pulse signal for determining the drive timings of the imaging unit.

The imaging unit 1 converts light from a subject by photoelectric conversion to generate an electric signal, and outputs the generated electric signal to the L/S separation unit.

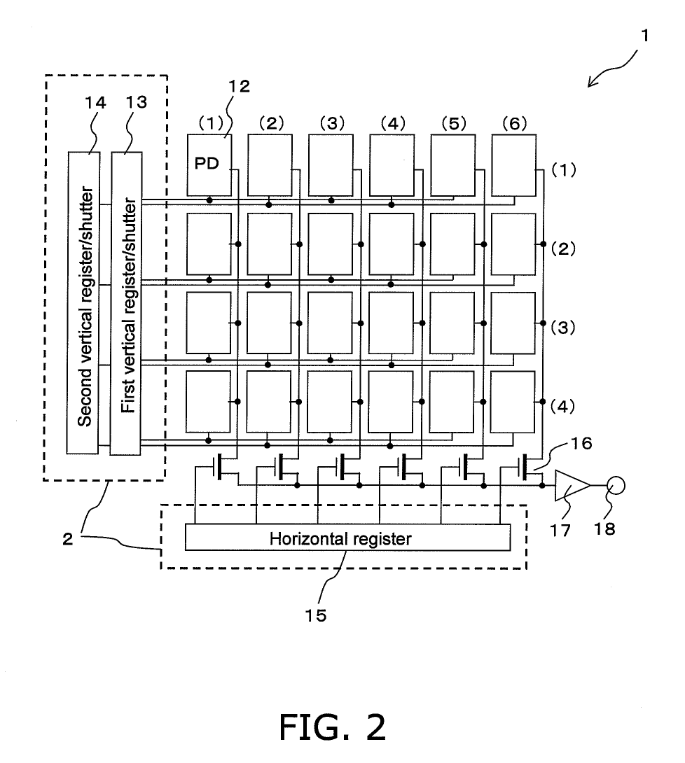

FIG. 2 shows the structure of the imaging unit 1 (when formed by a CMOS image sensor) and the drive unit 2. In FIG. 2, the imaging unit 1 includes six horizontally-arranged pixels by four vertically-arranged pixels. Each pixel 12 includes a photodiode. The number of pixels is specified only for the sake of explanation, and should not be limited to this number.

As shown in FIG. 2, the imaging unit 1 includes the pixels 12, which are arranged vertically and horizontally, a switching transistor 16, and an output amplifier 17. Each pixel 12 accumulates charge that is proportional to the amount of its incident light, and outputs an electric signal according to the amount of accumulated charge. It is preferable to use a CMOS sensor as the imaging unit 1.

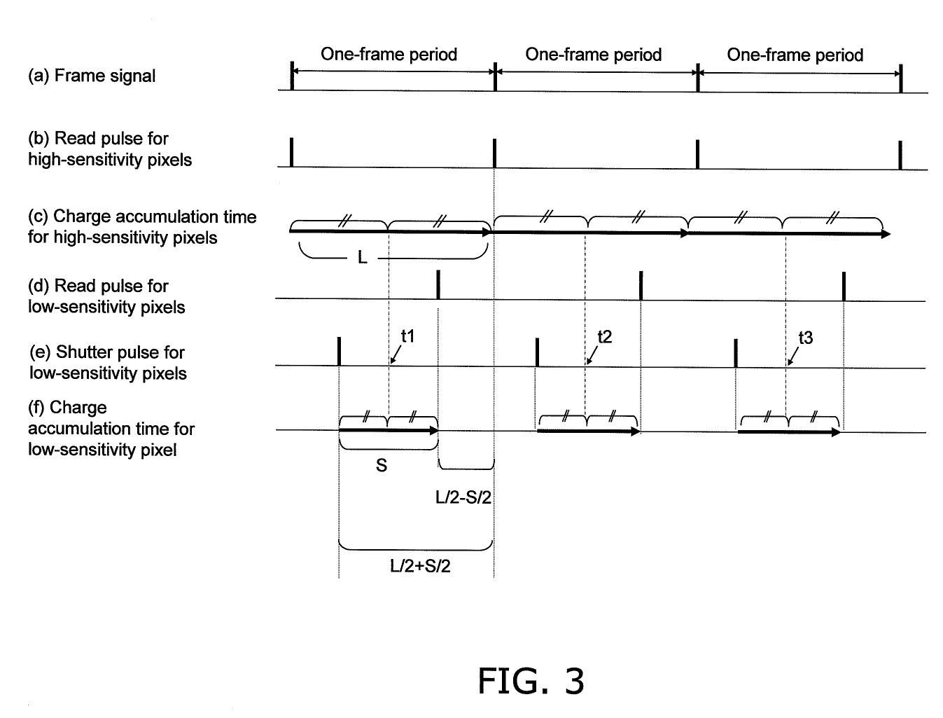

The drive unit 2 drives the imaging unit 1 based on control signals (including a sync signal for cameras and a drive pulse signal for determining the drive timings of the imaging unit 1), which are output from the timing generator unit 11. As shown in FIG. 2, the drive unit 2 includes a first vertical register/shutter 13, a second vertical register/shutter 14, and a horizontal register 15. The first vertical register/shutter 13 is connected to the pixels 12 arranged in the odd vertical lines. The first vertical register/shutter 13 selects a horizontal line address, and drives pixels 12 arranged at the selected addresses in the horizontal direction to accumulate charge (enables the electronic shutter function). The second vertical register/shutter 14 is connected to the pixels 12 arranged in the even vertical lines. The second vertical register/shutter 14 selects a horizontal line address, and drives pixels 12 arranged at the selected addresses in the horizontal direction to accumulate charge (enables the electric shutter function). For example, as shown in FIG. 3, the drive unit 2 determines the charge accumulation time and the charge accumulation timings for pixels with a long charge accumulation time (high-sensitivity pixels) and the charge accumulation time and the charge accumulation timings for pixels with a short charge accumulation time (low-sensitivity pixels). More specifically, the drive unit 2 drives the imaging unit 1 in a manner that the pixels with the long charge accumulation time (high-sensitivity pixels) start accumulating charge at the timing when a read pulse for high-sensitivity pixels is output, and stops accumulating charge at the timing when a next read pulse for high-sensitivity pixels is output. The drive unit 2 drives the imaging unit 1 in a manner that the pixels with the short charge accumulation time (low-sensitivity pixels) start accumulating charge at the timing when a shutter pulse for low-sensitivity pixels is output and stop accumulating charge at the timing when a next read pulse for high-sensitivity pixels is output. As shown in FIG. 3, the cycle of the read pulse for high-sensitivity pixels is assumed to be equal to the period corresponding to one frame, the charge accumulation time for high-sensitivity pixels is assumed to be L [sec], and the charge accumulation time for low-sensitivity pixels is assumed to be S [sec] (S<L). In this case, the drive unit 2 outputs a read pulse for high-sensitivity pixels at the same timing as (or at substantially the same timing as) when a frame signal is output. The drive unit 2 outputs a shutter pulse for low-sensitivity pixels at a delayed timing (this timing is referred to as “timing S1”) that is delayed by (L-S)/2 [sec] with respect to the timing when the read pulse for high-sensitivity pixels is output, and outputs a read pulse for low-sensitivity pixels at a delayed timing that is delayed by S [sec] with respect to the timing S1. As a result, the center time of the charge accumulation time for high-sensitivity pixels coincides with the center time of the charge accumulation time for low-sensitivity pixels (timings t1 to t3 in FIG. 3).

The first vertical register/shutter 13 and the second vertical register/shutter 14 may be formed by, for example, shift register circuits. The horizontal register 15 is connected to switching transistors 16, which are arranged to correspond in one-to-one to vertical lines of the pixels 12 as shown in FIG. 2. The horizontal register 15 selects a vertical line address (performs horizontal scanning). The horizontal register 15 selects a vertical line address by switching on a switching transistor 16 corresponding to the vertical line address. The output amplifier 17 is connected to the switching transistors 16 as shown in FIG. 2. When receiving an electric signal corresponding to the amount of charge accumulated in pixels 12 at the addresses selected by the second vertical register/shutter 14 and the horizontal register 15, the output amplifier 17 amplifies the input signal and outputs the amplified signal to the L/S separation unit 3 via an output terminal 18.

The imaging unit 1 and the drive unit 2 with the above-described structure enable the charge accumulation times of the pixels 12 to be controlled independently of one another, and enable the charge accumulation times to be adjusted easily to obtain image signals corresponding to one screen. For example, the imaging unit 1 and the drive unit 2 with the above-described structure easily set the charge accumulation time short for the pixels 12 arranged in the odd vertical lines and set the charge accumulation time long for the pixels 12 arranged in the even vertical lines.

For ease of explanation, the operation of the imaging apparatus when the charge accumulation time is set short for the pixels 12 arranged in the odd vertical lines and the charge accumulation time is set long for the pixels 12 arranged in the even vertical lines will now be described.

The L/S separation unit 3 separates each signal output from the imaging unit 1 depending on whether the charge accumulation time for the corresponding pixel 12 is long or short. The imaging unit 1 outputs a long-signal when the charge accumulation time for the pixel 12 is long. The imaging unit 1 outputs a short-signal when the charge accumulation time for the pixel 12 is short. In this case, the L/S separation unit 3 outputs the long-signal to the saturation detection unit 4 and the selector unit 8, and outputs the short-signal to the multiplier unit 6. The L/S separation unit 3 receives control signals from the timing generator unit 11. Based on the control signals from the timing generator unit 11, the L/S separation unit 3 outputs the long-signal and the short-signal.

The saturation detection unit 4 receives the long-signal output from the L/S separation unit 3, and detects whether the level of the long-signal obtained from the pixels 12 with the long charge accumulation time exceeds a predetermined level, and outputs the detection result to the selector unit 8.

The correction value calculation unit 5 calculates a correction value for correcting the output level of a pixel (output level of an electric signal output from the pixel 12), which changes depending on the charge accumulation time of the pixel. The correction value calculation unit 5 calculates the correction value based on the charge accumulation time for the pixel 12 from which the long-signal is generated and the charge accumulation time for the pixel 12 from which the short-signal is generated. The correction value calculation unit 5 obtains, from the timing generator unit 11, information about the charge accumulation time for the pixel 12 from which the long-signal is generated and information about the charge accumulation time for the pixel 12 from which the short-signal is generated. The correction value calculation unit 5 calculates the correction value based on the information, and outputs the calculated correction value to the multiplier unit 6.

The multiplier unit 6 multiplies the correction value output from the correction value calculation unit 5 and the short-signal output from the L/S separation unit 3, and outputs the resulting signal to the interpolation unit 7 and the L/S combining unit 9 as a corrected short-signal.

Based on the corrected short-signal output from the multiplier unit 6, the interpolation unit 7 generates an interpolated long-signal, which has the same timing as the timing corresponding to the center point of the corrected short-signal, or in other words the same timing as the timing of the long-signal, and outputs the generated interpolated long-signal to the selector unit 8. The interpolation unit 7 calculates the average of two sequential corrected short-signals (calculates, for example, the arithmetic average or the geometric average of the two signals or subjects the signals to low-pass filtering) to generate an interpolated long-signal.

The selector unit 8 receives the detection result of the saturation detection unit 4, the long-signal output from the L/S separation unit 3, and the interpolated long-signal output from the interpolation unit 7. When the saturation detection unit 4 determines that the level of the long-signal is below or equal to a predetermined level, the selector unit 8 outputs the long-signal as a corrected long-signal to the L/S combining unit 9. When the saturation detection unit 4 determines that the long-signal exceeds a predetermined level, the selector unit 8 outputs the interpolated long-signal to the L/S combining unit 9 as a corrected long-signal.

The L/S combining unit 9 receives the corrected long-signal output from the selector unit 8, the corrected short-signal output from the multiplier unit 6, and the control signals from the timing generator unit. Based on the control signals from the timing generator unit, the L/S combining unit 9 sequentially switches the corrected long-signal and the corrected short-signal and outputs the selected signal to the process unit 10 as a video signal.

The process unit 10 subjects the video signal output from the L/S combining unit 9 to signal processing for cameras, such as gamma correction and detail enhancement.

The timing generator unit 11 generates signals including a sync signal for cameras and a drive pulse signal for determining the drive timings of the imaging unit 1, and outputs the signals to the drive unit 2. The timing generator unit 11 outputs a control signal for adjusting the timing of an output signal to the L/S separation unit 3 and the L/S combining unit 9. The timing generator unit 11 outputs information about the charge accumulation time for the pixel 12 from which the long-signal is generated and the charge accumulation time for the pixel 12 from which the short-signal is generated, to the correction value calculation unit 5. The timing generator unit 11 functions as the charge accumulation time setting unit.

### Operation of the Imaging Apparatus

The operation of the imaging apparatus 100 with the above-described structure will now be described with reference to FIGS. 1 to 4.

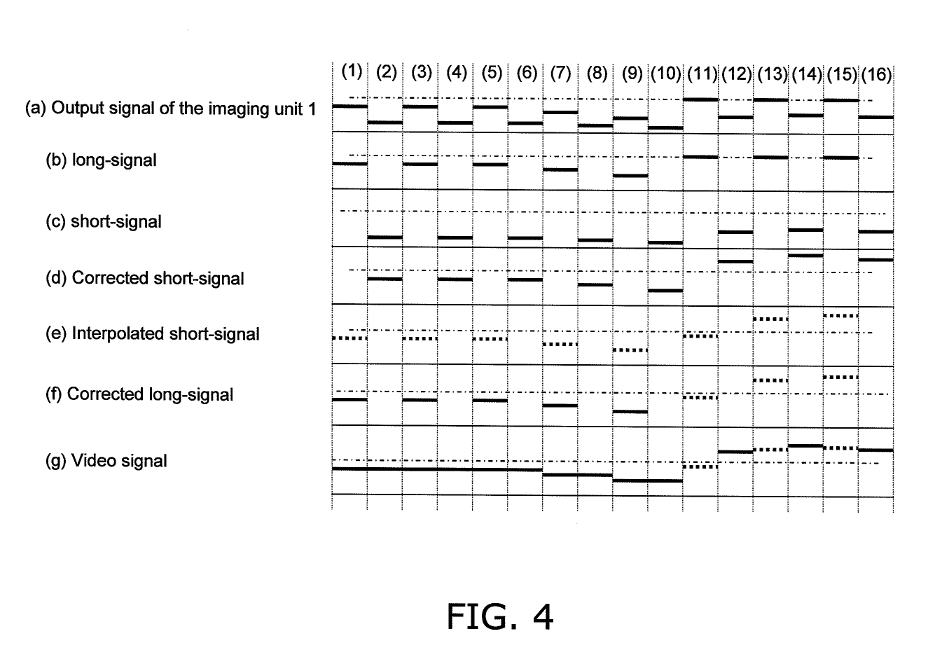

FIG. 4 is a timing chart showing the waveform of signals corresponding to points a to g in the imaging apparatus 100 shown in FIG. 1. In FIG. 4, the vertical axis indicates the signal level, whereas the horizontal axis indicates the time.

In the imaging unit 1 (CMOS image sensor) shown in FIG. 2, the charge accumulation time is set long for pixels arranged in odd vertical lines, whereas the charge accumulation time is set short for pixels arranged in even vertical lines. The charge accumulation times for the pixels are set by setting the first vertical register/shutter 13 and the second vertical register/shutter 14. The imaging unit 1 includes the first vertical register/shutter 13 and the second vertical register/shutter 14 that easily enable different pixels to be driven differently. Thus, the imaging unit 1 can set the shutter speed differently for different pixels. Controlling pixels differently in this manner is difficult when the image sensor is formed by a CCD.

Signals with the long charge accumulation time obtained from pixels arranged in odd vertical lines and signals with the short charge accumulation time obtained from pixels arranged in even vertical lines are output to the output terminal 18 via the output amplifier 17 when the horizontal register 15 switches on the switching transistors 16, which are arranged in the horizontal direction. FIG. 4(a) shows an example of an output signal of the imaging unit 1 (CMOS image sensor).

In FIG. 4, signal parts with odd numbers, which are written at the top, are long-signals with the long charge accumulation time. Signal parts with even numbers are short-signals with the short charge accumulation time. The L/S separation unit 3 separates an output signal from the imaging unit 1 into a long-signal and a short-signal. FIG. 4(b) shows long-signals separated by the L/S separation unit 3. FIG. 4(c) shows short-signals separated by the L/S separation unit 3.

The long-signals are signals obtained with the charge accumulation time and the timings shown in FIG. 3(c). The short-signals are signals obtained with the charge accumulation time and the timings shown in FIG. 3(f).

The multiplier unit 6 converts each short-signal output from the L/S separation unit 3 to a corrected short-signal by multiplying the short-signal by the correction coefficient (=the long charge accumulation time/the short charge accumulation time), which is calculated by the correction value calculation unit 5. FIG. 4(d) shows corrected short-signals.

The interpolation unit 7 generates an interpolated signal using the corrected short-signals, and then converts the signal to a signal having the same timing as the long-signal output from the L/S separation unit 3. The resulting signal is referred to as an interpolated long-signal. FIG. 4(e) shows interpolated long-signals. The interpolation unit 7 generates an interpolated-long signal by, for example, averaging two sequential corrected short-signals and adjusting the timing of the resulting average signal to the same timing as each long-signal. More specifically, the interpolation unit 7 generates an interpolated long-signal by averaging the corrected short-signal (2) in FIG. 4 and the corrected short-signal (4) in FIG. 4 and adjusting the timing of the resulting average signal to the same timing as the long-signal (3) in FIG. 4. Alternatively, the interpolation unit 7 may generate an interpolated long-signal simply by delaying each corrected short-signal to have the same timing as the long-signal.

The corrected long-signal is generated when the selector unit 8 selects the long-signal output from the L/S separation unit 3 and the interpolated long-signal output from the interpolation unit 7 based on the detection result of the saturation detection unit 4. This will now be described with reference to FIG. 4. In FIG. 4, the signal level indicated by a broken line is assumed as a predetermined value. For signal parts (1), (3), (5), (7), and (9) whose signal level does not exceed the predetermined value, the selector unit 8 selects a long-signal and outputs the long-signal as the corrected long-signal. For signal parts (11), (13), and (15) whose signal level exceeds the predetermined value, the selector unit 8 selects an interpolated long-signal and outputs the interpolated long-signal as the corrected long-signal. FIG. 4(f) shows corrected long-signals.

The L/S combining unit 9 sequentially fetches the corrected short-signal and the corrected long-signal and combines the signals, and finally outputs the resulting combined signal as a video signal. FIG. 4(g) shows the video signal. As shown in FIG. 4(g), the video signal reproduces, without saturation, signal parts (11), (13), and (15), although the signal level of the signal parts (11), (13), and (15) of the output signal from the imaging unit 1 are saturated. In other words, the video signal has a large dynamic range. More specifically, the imaging apparatus 100 reproduces signals corresponding to all pixels of the imaging unit 1 to be reproduced without saturation, and therefore enables its video signal to have high resolution. Also, the imaging apparatus 100 of the present invention generates the long-signals and the short-signals in a manner that the center time of the charge accumulation time for long-signals and the center time of the charge accumulation time for short-signals coincide with each other. Therefore, even when the imaging apparatus 100 of the present invention processes video that contains excessive movement within a one-frame (or field) period, the imaging apparatus 100 prevents the video from blurring, while increasing the dynamic range of signals.

Although the above embodiment describes the case in which the imaging apparatus 100 uses separate processing channels for long-signals and short-signals, the imaging apparatus 100 may not use separate processing channels but may process long-signals and short-signals in chronological order (time division processing) through digital processing.

Although the above embodiment describes the case in which the imaging unit 1 includes pixels with long and short charge accumulation times that are arranged alternately in the horizontal direction, the pixels with long and short charge accumulation times may be arranged alternately in the vertical direction. This structure also has the same advantageous effects as the structure described above.

The present invention is also applicable to an imaging apparatus in which R, C, and B imaging units (CMOS image sensors) are formed separately, such as an imaging apparatus with a triple-sensor structure. In this case, the imaging apparatus 100 is only required to include three processing systems each with the structure described in FIG. 1 separately for the R, and B imaging units.

Although the imaging apparatus 100 of the present invention corrects the level of short-signals, the imaging apparatus 100 may instead correct the level of long-signals. This structure also has the same advantageous effects as the structure described above.

### Other Embodiments

In the above embodiment, the image signals are processed in units of frames, but the image signals may be processed in units of fields.

In the above embodiment, each block of the imaging apparatus may be formed by a single chip with semiconductor device technology, such as LSI (large-scale integration), or some or all of the blocks of the imaging apparatus may be formed by a single chip.

Although the semiconductor device technology is referred to as LSI, the technology may be instead referred to as IC (integrated circuit), system LSI, super LSI, or ultra LSI depending on the degree of integration of the circuit.

The circuit integration technology employed should not be limited to LSI, but the circuit integration may be achieved using a dedicated circuit or a general-purpose processor. A field programmable gate array (FPGA), which is an LSI circuit programmable after manufactured, or a reconfigurable processor, which is an LSI circuit in which internal circuit cells are reconfigurable or more specifically the internal circuit cells can be reconnected or reset, may be used.

Further, if any circuit integration technology that can replace LSI emerges as an advancement of the semiconductor technology or as a derivative of the semiconductor technology, the technology may be used to integrate the functional blocks of the imaging apparatus. Biotechnology is potentially applicable.

The processes described in the above embodiment may be realized using either hardware or software, or may be realized using both software and hardware.

The structure described in detail in the above embodiment is a mere example of the present invention, and may be changed and modified variously without departing from the scope and spirit of the invention.

The imaging apparatus, the imaging method, and the integrated circuit of the present invention eliminate a time lag between images caused by different charge accumulation times, and enable video or an image including a moving image to be captured with a large dynamic range and with high resolution. Therefore, the present invention is applicable to an imaging apparatus, an imaging method, and an integrated circuit that require a large dynamic range, such as an imaging apparatus, an imaging method, and an integrated circuit used in tunnels for example or used for security purpose.

1. An imaging apparatus, comprising:
an imaging unit that includes an image sensor and converts light from a subject to an electric signal to obtain a video signal, the image sensor having a plurality of pixels for each of which a charge accumulation time is set independently, the pixels being divided in a first group of pixels that accumulate charge for a first charge accumulation time and a second group of pixels that accumulate charge for a second charge accumulation time longer than the first charge accumulation time;
a charge accumulation time setting unit that sets the first charge accumulation time and the second charge accumulation time;
a drive unit that drives the imaging unit based on the first charge accumulation time and the second charge accumulation time;
an L/S separation unit that separates the video signal output from the imaging unit into a short-signal that is a video signal obtained with the first charge accumulation time and a long-signal that is a video signal obtained with the second charge accumulation time;
a saturation detection unit that detects a signal level of the long-signal;
a correction value calculation unit that calculates a correction value used to correct a signal level of the short-signal to the signal level of the long-signal based on the first charge accumulation time and the second charge accumulation time;
a multiplier unit that multiplies the short-signal by the correction value calculated by the correction value calculation unit to obtain a corrected short-signal;
an interpolation unit that performs interpolation using the corrected short-signal to generate an interpolated long-signal having a timing identical to a timing of the long-signal;
a selector unit that selects the long-signal when the saturation detection unit determines that the signal level of the long-signal is below or equal to a predetermined value, and selects the interpolated long-signal when the saturation detection unit determines that the signal level of the long-signal exceeds the predetermined value, and obtains the selected signal as a corrected long-signal; and
an L/S combining unit that generates an output video signal by sequentially switching the corrected long signal output from the selector unit and the corrected short-signal output from the multiplier unit,
wherein the drive unit drives the imaging unit in a manner that a center time of the first charge accumulation time and a center time of the second charge accumulation time coincide with each other.

2. The imaging apparatus according to claim 1,
wherein the charge accumulation time setting unit sets an output timing of a second charge accumulation time start pulse signal used to determine the second charge accumulation time, an output timing of a first charge accumulation time start pulse signal used to determine the first charge accumulation time, and an output timing of a first charge accumulation time stop pulse signal, and
the drive unit drives the imaging unit in a manner that charge accumulation in the second group of pixels is started based on the second charge accumulation time start pulse signal and the charge accumulation in the second group of pixels is performed for the second charge accumulation time, and the drive unit drives the imaging unit in a manner that charge accumulation in the first group of pixels is started based on the first charge accumulation time start pulse signal and the charge accumulation in the first group of pixels is stopped based on the first charge accumulation time stop pulse signal.

3. The imaging apparatus according to claim 1,
wherein the image sensor includes the pixels arranged in a plurality of horizontal lines and a plurality of vertical lines, and the pixels included in the first group are arranged in odd vertical lines and the pixels included in the second group are arranged in even vertical lines.

4. The imaging apparatus according to claim 1,
wherein the image sensor includes the pixels arranged in a plurality of horizontal lines and a plurality of vertical lines, and the pixels included in the first group are arranged in even vertical lines and the pixels included in the second group are arranged in odd vertical lines.

5. The imaging apparatus according to claim 1,
wherein the image sensor includes the pixels arranged in a plurality of horizontal lines and a plurality of vertical lines, and the pixels included in the first group are arranged in odd horizontal lines and the pixels included in the second group are arranged in even horizontal lines.

6. The imaging apparatus according to claim 1,
wherein the image sensor includes the pixels arranged in a plurality of horizontal lines and a plurality of vertical lines, and the pixels included in the first group are arranged in even horizontal lines and the pixels included in the second group are arranged in odd horizontal lines.

7. The imaging apparatus according to claim 1,
wherein the image sensor is a complementary metal oxide semiconductor image sensor.

8. An imaging method used in an imaging apparatus including an imaging unit that includes an image sensor and converts light from a subject to an electric signal to obtain a video signal, the image sensor having a plurality of pixels for each of which a different charge accumulation time can be set, the pixels being divided in a first group of pixels that accumulate charge for a first charge accumulation time and a second group of pixels that accumulate charge for a second charge accumulation time longer than the first charge accumulation time, the method comprising:
setting the first charge accumulation time and the second charge accumulation time;
driving the imaging unit based on the first charge accumulation time and the second charge accumulation time;
separating the video signal output from the imaging unit into a short-signal that is a video signal obtained with the first charge accumulation time and a long-signal that is a video signal obtained with the second charge accumulation time;
detecting a signal level of the long-signal;
calculating a correction value used to correct a signal level of the short-signal to the signal level of the long-signal based on the first charge accumulation time and the second charge accumulation time;
multiplying the short-signal by the correction value calculated in the correction value calculation step to obtain a corrected short-signal;
performing interpolation using the corrected short-signal to generate an interpolated long-signal having a timing identical to a timing of the long-signal;
selecting the long-signal when the signal level of the long-signal is determined to be below or equal to a predetermined value in the saturation detection step, and selecting the interpolated long-signal when the signal level of the long-signal is determined to exceed the predetermined value in the saturation detection step, and obtaining the selected signal as a corrected long-signal; and
generating an output video signal by sequentially switching the corrected long signal obtained in the selector step and the corrected short-signal obtained in the multiplier step,
wherein in the drive step, the imaging unit is driven in a manner that a center time of the first charge accumulation time and a center time of the second charge accumulation time coincide with each other.

9. An integrated circuit that is used together with an imaging unit including an image sensor having a plurality of pixels for each of which a charge accumulation time is set independently, the pixels being divided in a first group of pixels that accumulate charge for a first charge accumulation time and a second group of pixels that accumulate charge for a second charge accumulation time longer than the first charge accumulation time, the integrated circuit comprising:
a charge accumulation time setting unit that sets the first charge accumulation time and the second charge accumulation time;
a drive unit that drives the imaging unit based on the first charge accumulation time and the second charge accumulation time;
an L/S separation unit that separates the video signal output from the imaging unit into a short-signal that is a video signal obtained with the first charge accumulation time and a long-signal that is a video signal obtained with the second charge accumulation time;
a saturation detection unit that detects a signal level of the long-signal;
a correction value calculation unit that calculates a correction value used to correct a signal level of the short-signal to the signal level of the long-signal based on the first charge accumulation time and the second charge accumulation time;
a multiplier unit that multiplies the short-signal by the correction value calculated by the correction value calculation unit to obtain a corrected short-signal;
an interpolation unit that performs interpolation using the corrected short-signal to generate an interpolated long-signal having a timing identical to a timing of the long-signal;
a selector unit that selects the long-signal when the saturation detection unit determines that the signal level of the long-signal is below or equal to a predetermined value, and selects the interpolated long-signal when the saturation detection unit determines that the signal level of the long-signal exceeds the predetermined value, and obtains the selected signal as a corrected long-signal; and
an L/S combining unit that generates an output video signal by sequentially switching the corrected long signal output from the selector unit and the corrected short-signal output from the multiplier unit,
wherein the drive unit drives the imaging unit in a manner that a center time of the first charge accumulation time and a center time of the second charge accumulation time coincide with each other.

10. An integrated circuit, comprising:
an imaging unit that includes an image sensor and converts light from a subject to an electric signal to obtain a video signal, the image sensor having a plurality of pixels for each of which a charge accumulation time is set independently, the pixels being divided in a first group of pixels that accumulate charge for a first charge accumulation time and a second group of pixels that accumulate charge for a second charge accumulation time longer than the first charge accumulation time;
a charge accumulation time setting unit that sets the first charge accumulation time and the second charge accumulation time;
a drive unit that drives the imaging unit based on the first charge accumulation time and the second charge accumulation time;
an L/S separation unit that separates the video signal output from the imaging unit into a short-signal that is a video signal obtained with the first charge accumulation time and a long-signal that is a video signal obtained with the second charge accumulation time;
a saturation detection unit that detects a signal level of the long-signal;
a correction value calculation unit that calculates a correction value used to correct a signal level of the short-signal to the signal level of the long-signal based on the first charge accumulation time and the second charge accumulation time;
a multiplier unit that multiplies the short-signal by the correction value calculated by the correction value calculation unit to obtain a corrected short-signal;
an interpolation unit that performs interpolation using the corrected short-signal to generate an interpolated long-signal having a timing identical to a timing of the long-signal;
a selector unit that selects the long-signal when the saturation detection unit determines that the signal level of the long-signal is below or equal to a predetermined value, and selects the interpolated long-signal when the saturation detection unit determines that the signal level of the long-signal exceeds the predetermined value, and obtains the selected signal as a corrected long-signal; and
an L/S combining unit that generates an output video signal by sequentially switching the corrected long signal output from the selector unit and the corrected short-signal output from the multiplier unit,
wherein the drive unit drives the imaging unit in a manner that a center time of the first charge accumulation time and a center time of the second charge accumulation time coincide with each other.
